(19) United States
(12) Patent Application Publication
(10) Pub. No.: US 2025/0273190 A1
(43) Pub. Date: Aug. 28, 2025

(54) APPARATUS FOR PREDICTING SQUEAL NOISE AND METHOD OF CONTROLLING SAME

(71) Applicants: HYUNDAI MOTOR COMPANY, Seoul (KR); Kia Corporation, Seoul (KR)

(72) Inventors: Sung Hyun CHO, Hwaseong-si (KR); Sung Ho KIM, Hwaseong-si (KR); Jung Ro YOON, Hwaseong-si (KR); Jeong Kyu KIM, Hwaseong-si (KR); Yoon Cheol KIM, Hwaseong-si (KR); Kyung Rok CHOI, Hwaseong-si (KR)

(73) Assignees: HYUNDAI MOTOR COMPANY, Seoul (KR); Kia Corporation, Seoul (KR)

(21) Appl. No.: 18/951,537

(22) Filed: Nov. 18, 2024

(30) Foreign Application Priority Data
Feb. 28, 2024 (KR) 10-2024-0029180

(51) Int. Cl. G10K 11/175; B60T 8/17; G06N 5/022; G07C 5/02

(52) U.S. Cl. CPC G10K 11/1752; B60T 8/17; G06N 5/022; G07C 5/02

(57) ABSTRACT

In an apparatus for predicting squeal noise and a method of controlling the same. The apparatus includes a processor which may identify first input data extracted from a braking device of a vehicle, second input data corresponding to a vehicle wheel, third input data measured from an external sensor, or a combination thereof, obtain first output data on a probability that the squeal noise may be generated in the braking device, second output data on a frequency of the squeal noise, and third output data on an amplitude of the squeal noise by applying the data to a squeal noise prediction model, and output target noise and, by use of the target noise, cancels out the squeal noise that corresponds to the second output data and the third output data and is generated from the braking device based on the squeal noise expected to be generated from the braking device through the first output data.

### CROSS-REFERENCE TO RELATED APPLICATION

The present application claims priority to Korean Patent Application No. 10-2024-0029180, filed on Feb. 28, 2024, the entire contents of which is incorporated herein for all purposes by this reference.

### BACKGROUND OF THE PRESENT DISCLOSURE

### Field of the Present Disclosure

The present disclosure relates to an apparatus for predicting squeal noise and a method of controlling the same, and more particularly, to a technology for predicting squeal noise which may occur during braking and providing noise canceling to cancel the squeal noise.

### Description of Related art

The braking device of a vehicle is a device that performs braking by converting the rotational kinetic energy of wheels into heat energy through friction between a disk and a pad. Therefore, resonance may occur in the braking device due to the exciting energy between the disk and the pad, and noise may occur when the resonance exceeds the damping limit of the system.

In the instant case, when noise falls within the frequency range of 1 to 16 kHz, the noise is squeal noise, and the sound is unpleasant, which is a major complaint among users. However, a vehicle is designed to prevent squeal noise of the braking device at a vehicle development stage. However, as time passes, wear may occur on the disks and pads included in the braking device and the vibration characteristics of the braking device may change, so noise that did not occur at the development stage may be generated.

There is a need to develop technology to predict squeal noise and technology to reduce predicted squeal noise.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing apparatus for predicting squeal noise and a method of controlling the same that reflect the relationship between rapid changes in the friction coefficient between a disk and a pad and torque estimates to predict the squeal noise by identifying vehicle state data including first input data extracted from the braking device of a vehicle, second input data corresponding to the wheels of the vehicle, and third input data measured from external sensors of the vehicle, and obtaining the probability that squeal noise is expected to be generated.

Another aspect of the present disclosure provides an apparatus for predicting squeal noise and a method of controlling the same that provide users with expected squeal noise characteristics and squeal noise generation conditions by applying vehicle state data to a squeal noise prediction model, and obtaining first output data on the probability that squeal noise is expected to be generated in a braking device, second output data on the frequency of the squeal noise, and third output data on the amplitude of the squeal noise.

Yet another aspect of the present disclosure provides an apparatus for predicting squeal noise and a method of controlling the same that reflect the level of squeal noise perception from the user's perspective and provide a squeal noise reduction function differentiated depending on the user to maximize driving satisfaction by identifying the locations of the occupants boarding a vehicle and outputting target noise for reducing the squeal noise to the identified locations.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an apparatus for predicting squeal noise includes a memory that stores computer-executable instructions, and at least one processor operably connected to the memory and configured to access the memory and execute the instructions, wherein the at least one processor may identify vehicle state data including at least one of first input data extracted from a braking device of a vehicle, second input data corresponding to a wheel of the vehicle, third input data measured from an external sensor of the vehicle, or a combination thereof, obtain first output data on a probability that the squeal noise is expected to be generated in the braking device, second output data on a frequency of the squeal noise, and third output data on an amplitude of the squeal noise by applying the vehicle state data to a squeal noise prediction model, and output target noise and, by use of the target noise, cancels out the squeal noise that corresponds to the second output data and the third output data and is generated from the braking device based on the squeal noise expected to be generated from the braking device through the first output data.

According to an exemplary embodiment of the present disclosure, the at least one processor may identify first noise data measured from a first external device provided in the vehicle and second noise data measured from a second external device of a user operating the vehicle, and include at least one of the first noise data, the second noise data, or a combination thereof in the vehicle state data.

According to an exemplary embodiment of the present disclosure, the at least one processor may identify at least one of outside air temperature measured from the external sensor, soaking time of the vehicle, or a combination thereof based on the squeal noise expected to be generated in the braking device through the first output data, identify a first sub-condition comparing the outside air temperature with a first threshold value, and a second sub-condition comparing the soaking time with a second threshold value, and output the target noise based on the first sub-condition and the second sub-condition.

According to an exemplary embodiment of the present disclosure, the at least one processor is configured to determine a plurality of sub-areas by dividing an area of the vehicle by a predetermined number based on a center portion of the vehicle, determine squeal noise prediction sub-models corresponding to each of the sub-areas, and obtain the first output data, the second output data, and the third output data corresponding to each of the sub-areas to apply the vehicle state data to each of the squeal noise prediction sub-models.

According to an exemplary embodiment of the present disclosure, the at least one processor may identify locations of occupants boarding the vehicle based on the squeal noise expected to be generated in the braking device, and determine the identified location as a location to which the target noise outputs.

According to an exemplary embodiment of the present disclosure, the at least one processor is configured to determine first location data for identifying the locations of the occupants boarding the vehicle based on a weight sensor included in the vehicle, determine second location data for identifying the locations of the occupants boarding the vehicle based on at least one of an ultrasonic sensor, a radio detection and ranging (RADAR) sensor, or a combination thereof included in the vehicle, determine third location data for identifying the locations of the occupants boarding the vehicle based on a connection between the vehicle and portable terminals of the occupants boarding the vehicle, and identify the locations of the occupants boarding the vehicle based on at least one of the first location data, the second location data, the third location data, or a combination thereof.

According to an exemplary embodiment of the present disclosure, the at least one processor may provide a notification to a driver of the vehicle to input a priority of a location to which the target noise outputs, based on a number of the identified locations being at least one, and output the target noise for each location corresponding to the priority based on inputting of the priority.

According to an exemplary embodiment of the present disclosure, the at least one processor is configured to determine whether the squeal noise of the braking device occurs based on a comparison of the first output data and a predetermined threshold value, and output the target noise through a sound actuator included in the vehicle based on the squeal noise expected to be generated in the braking device.

According to another aspect of the present disclosure, a method of predicting squeal noise includes identifying vehicle state data including at least one of first input data extracted from a braking device of a vehicle, second input data corresponding to a wheel of the vehicle, third input data measured from an external sensor of the vehicle, or a combination thereof, obtaining first output data on a probability that the squeal noise is expected to be generated in the braking device, second output data on a frequency of the squeal noise, and third output data on an amplitude of the squeal noise by applying the vehicle state data to a squeal noise prediction model, and outputting target noise that cancels out the squeal noise that corresponds to the second output data and the third output data and is generated from the braking device based on the squeal noise expected to be generated from the braking device through the first output data.

According to an exemplary embodiment of the present disclosure, the identifying of the vehicle state data may include identifying first noise data measured from a first external device provided in the vehicle and second noise data measured from a second external device of a user operating the vehicle, and including at least one of the first noise data, the second noise data, or a combination thereof in the vehicle state data.

According to an exemplary embodiment of the present disclosure, the outputting of the target noise may include identifying at least one of outside air temperature measured from the external sensor, soaking time of the vehicle, or a combination thereof based on the squeal noise expected to be generated in the braking device through the first output data, identifying a first sub-condition comparing the outside air temperature with a first threshold value, and a second sub-condition comparing the soaking time with a second threshold value, and outputting the target noise based on the first sub-condition and the second sub-condition.

According to an exemplary embodiment of the present disclosure, the method may further include determining a plurality of sub-areas by dividing an area of the vehicle by a predetermined number based on a center portion of the vehicle, determining squeal noise prediction sub-models corresponding to each of the sub-areas, and obtaining the first output data, the second output data, and the third output data corresponding to each of the sub-areas to apply the vehicle state data to each of the squeal noise prediction sub-models.

According to an exemplary embodiment of the present disclosure, the outputting of the target noise may include identifying locations of occupants boarding the vehicle based on the squeal noise expected to be generated in the braking device, and determining the identified location as a location to which the target noise outputs.

According to an exemplary embodiment of the present disclosure, the identifying of the locations of the occupants may include determining first location data for identifying the locations of the occupants boarding the vehicle based on a weight sensor included in the vehicle, determining second location data for identifying the locations of the occupants boarding the vehicle based on at least one of an ultrasonic sensor, a radar sensor, or a combination thereof included in the vehicle, determining third location data for identifying the locations of the occupants occupant boarding the vehicle based on a connection between the vehicle and portable terminals of the occupants boarding the vehicle, and identifying the locations of the occupants boarding the vehicle based on at least one of the first location data, the second location data, the third location data, or a combination thereof.

According to an exemplary embodiment of the present disclosure, the outputting of the target noise may include providing a notification to a driver of the vehicle to input a priority of a location to which the target noise outputs, based on a number of the identified locations being at least one, and outputting the target noise for each location corresponding to the priority based on inputting of the priority.

According to an exemplary embodiment of the present disclosure, the outputting of the target noise may include determining whether the squeal noise of the braking device occurs based on a comparison of the first output data and a predetermined threshold value, and outputting the target noise through a sound actuator included in the vehicle based on the squeal noise expected to be generated in the braking device.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a diagram illustrating an apparatus for predicting squeal noise according to an exemplary embodiment of the present disclosure;

FIG. 2 is a flowchart illustrating a method of predicting squeal noise according to an exemplary embodiment of the present disclosure;

FIG. 3 is a diagram illustrating a method of obtaining data for predicting whether squeal noise occurs by an apparatus for predicting squeal noise according to an exemplary embodiment of the present disclosure;

FIG. 4 is a diagram illustrating input data in an apparatus for predicting squeal noise according to an exemplary embodiment of the present disclosure;

FIG. 5 is a flowchart illustrating a method of outputting target noise in an apparatus for predicting squeal noise according to an exemplary embodiment of the present disclosure;

FIG. 6 is a flowchart illustrating a method of classifying the characteristics of squeal noise according to outside air temperature and soaking time in an apparatus for predicting squeal noise according to an exemplary embodiment of the present disclosure;

FIG. 7 is a flowchart illustrating the operation of a squeal noise prediction sub-model corresponding to a sub-region in an apparatus for predicting squeal noise according to an exemplary embodiment of the present disclosure;

FIG. 8 is a flowchart illustrating a method of outputting target noise according to the location of an occupant and target noise output priority in an apparatus for predicting squeal noise according to an exemplary embodiment of the present disclosure; and

FIG. 9 is a diagram illustrating a computing system related to an apparatus for predicting squeal noise or a method of controlling squeal noise according to various exemplary embodiments of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the exemplary drawings. In adding the reference numerals to the components of each drawing, it should be noted that the identical or equivalent component is predetermined by the identical numeral even when they are displayed on other drawings. Furthermore, in describing the exemplary embodiment of the present disclosure, a detailed description of the related known configuration or function will be omitted when it is determined that it interferes with the understanding of the exemplary embodiment of the present disclosure. Various embodiments of the present disclosure may be described with reference to accompanying drawings. Accordingly, those of ordinary skill in the art will recognize that modification, equivalent, and/or alternative on the various embodiments described herein may be variously made without departing from the scope and spirit of the present disclosure. With regard to description of drawings, similar elements may be marked by similar reference numerals.

Terms, such as first, second, A, B, (a), (b) or the like may be used herein when describing components of the present disclosure. The terms are provided only to distinguish the elements from other elements, and the essences, sequences, orders, and numbers of the elements are not limited by the terms. Furthermore, unless defined otherwise, all terms used herein, including technical or scientific terms, include the same meanings as those generally understood by those skilled in the art to which the present disclosure pertains. The terms defined in the generally used dictionaries should be construed as including the meanings that coincide with the meanings of the contexts of the related technologies, and should not be construed as ideal or excessively formal meanings unless clearly defined in the specification of the present disclosure. The terms, such as “first”, “second”, and the like used herein may refer to various elements of various embodiments of the present disclosure, but do not limit the elements. For example, “a first user device” and “a second user device” indicate different user devices regardless of the order or priority. For example, without departing the scope of the present disclosure, a first element may be referred to as a second element, and similarly, a second element may be referred to as a first element.

In an exemplary embodiment of the present disclosure included herein, the expressions “have”, “may have”, “include” and “comprise”, or “includes” and “may comprise” used herein indicate existence of corresponding features (e.g., elements such as numeric values, functions, operations, or components) but do not exclude presence of additional features.

It will be understood that when an element (e.g., a first element) is referred to as being “(operatively or communicatively) coupled with/to” or “connected to” another element (e.g., a second element), it may be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there is no intervening element (e.g., a third element).

According to the situation, the expression “configured to” used herein may be used as, for example, the expression “suitable for”, “having the capacity to”, “designed to”, “adapted to”, “made to”, or “capable of”.

The term “configured to” must not mean only “specifically designed to” in hardware. Instead, the expression “a device configured to” may mean that the device is “capable of” operating together with another device or other components. CPU, for example, a “processor configured to perform A, B, and C” may mean a dedicated processor (e.g., an embedded processor) for performing a corresponding operation or a generic-purpose processor (e.g., a central processing unit (CPU) or an application processor) which may perform corresponding operations by executing one or more software programs which are stored in a memory device. Terms used in an exemplary embodiment of the present disclosure are used to describe specified embodiments of the present disclosure and are not intended to limit the scope of the present disclosure. The terms of a singular form may include plural forms unless otherwise specified. All the terms used herein, which include technical or scientific terms, may include the same meaning which is generally understood by a person skilled in the art. It will be further understood that terms, which are defined in a dictionary and commonly used, should also be interpreted as is customary in the relevant related art and not in an idealized or overly formal sense unless expressly so defined herein in various embodiments of the present disclosure. In some cases, even if terms are terms which are defined in an exemplary embodiment of the present disclosure, they may not be interpreted to exclude embodiments of the present disclosure.

In an exemplary embodiment of the present disclosure included herein, the expressions “A or B”, “at least one of A or/and B”, or “one or more of A or/and B”, and the like used herein may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included. Furthermore, as used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. In particular, a phrase such as “at least one of A, B, C, or any combination thereof” may include A or B or C or a combination thereof such as AB or ABC.

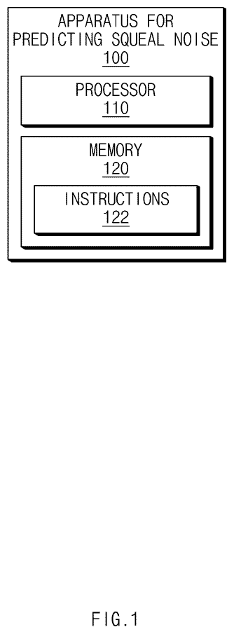

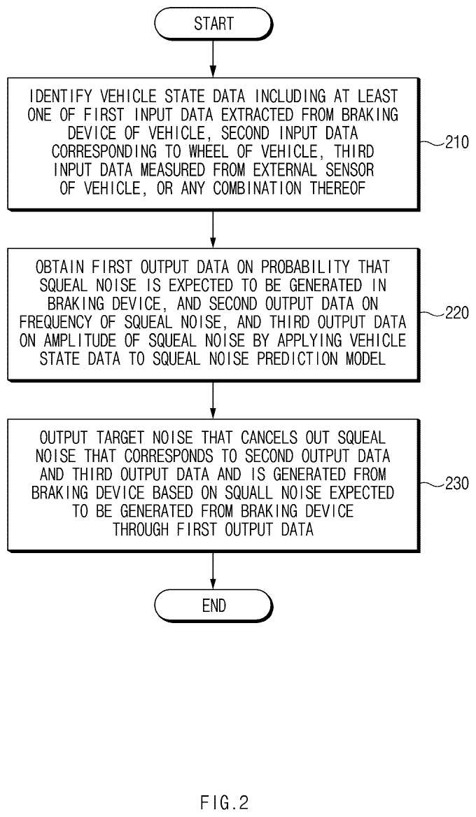

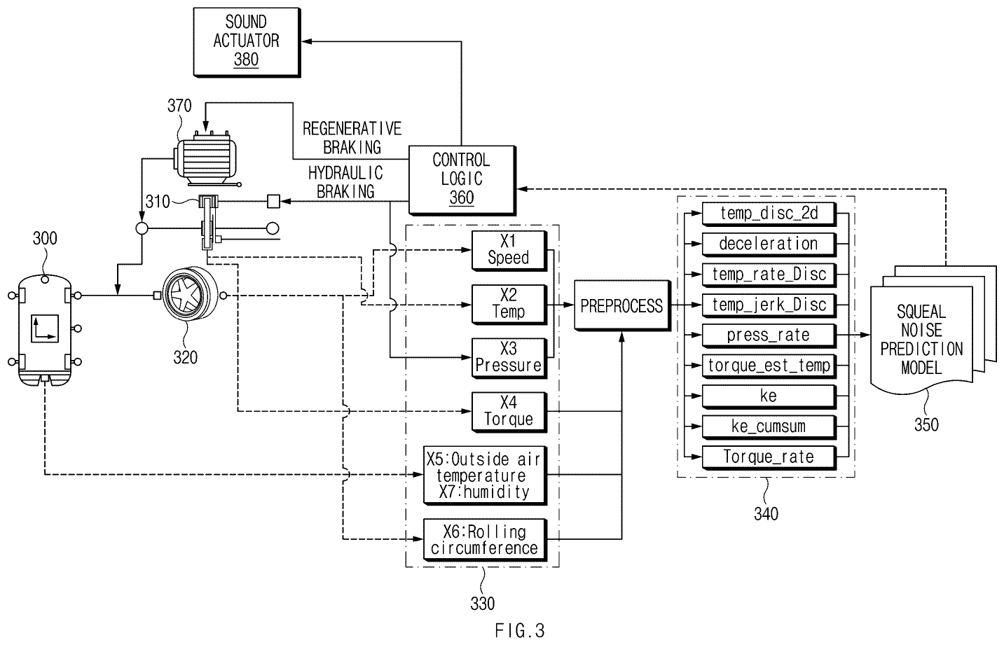

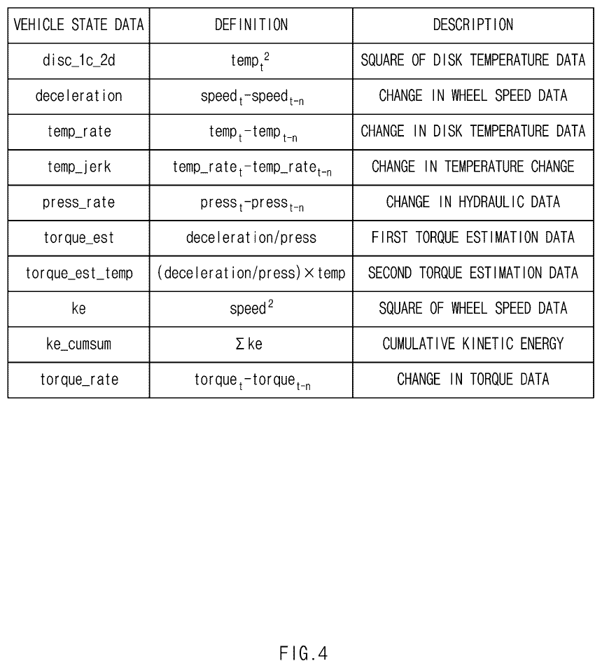

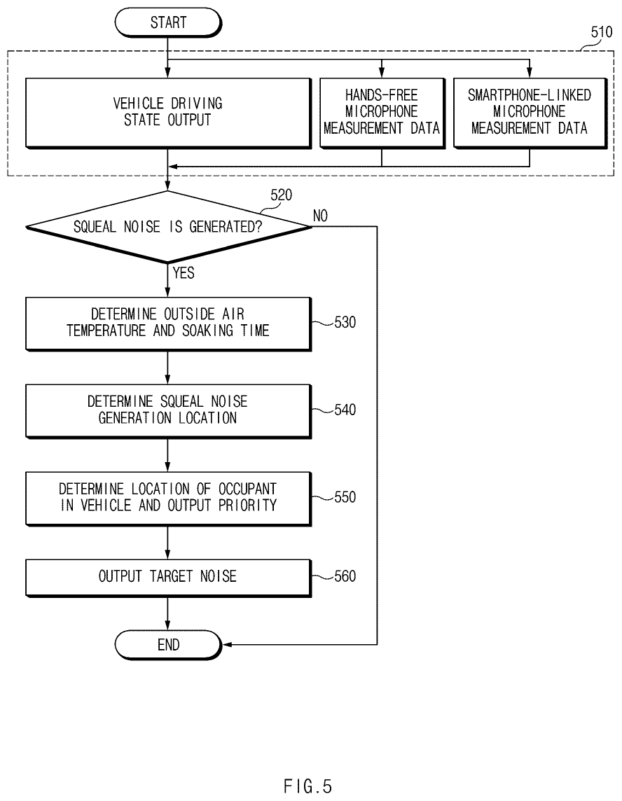

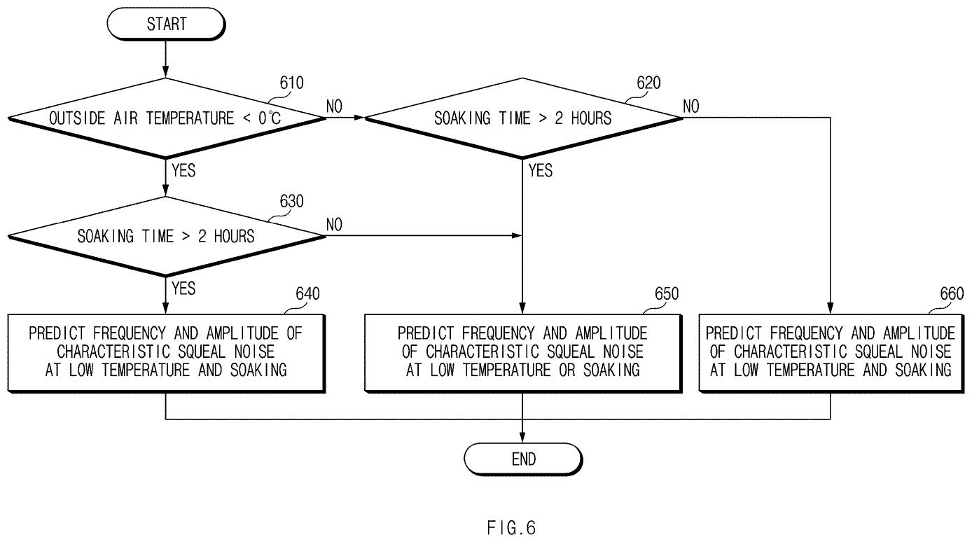

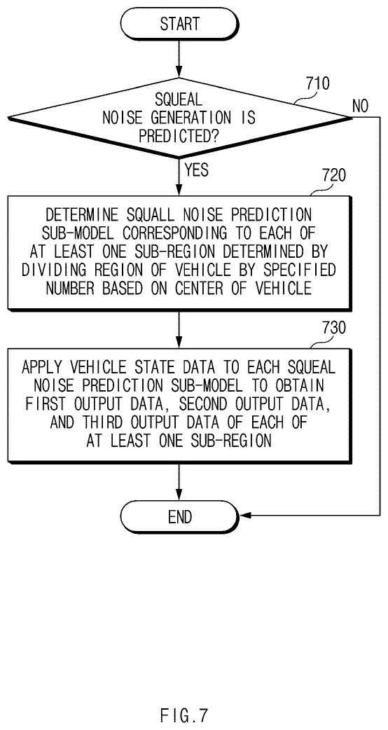

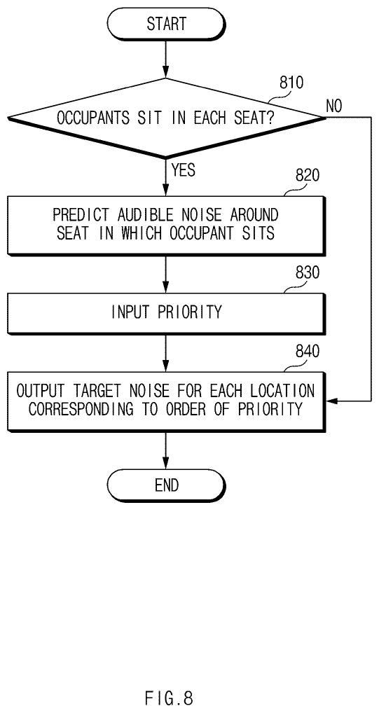

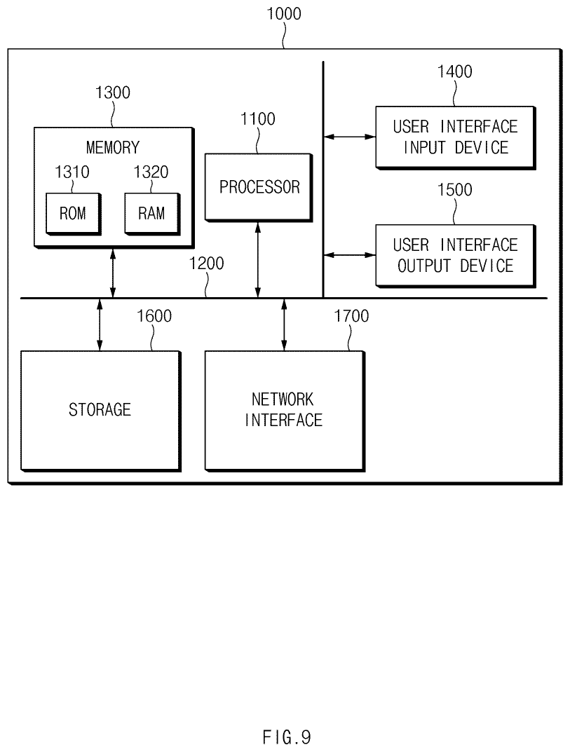

Hereinafter, various exemplary embodiments of the present disclosure will be described in detail with reference to FIG. 1, FIG. 2, FIG. 3, FIG. 4, FIG. 5, FIG. 6, FIG. 7, FIG. 8 and FIG. 9.

FIG. 1 is a diagram illustrating an apparatus for predicting squeal noise according to an exemplary embodiment of the present disclosure.

An apparatus 100 for predicting squeal noise according to various exemplary embodiments of the present disclosure may include a processor 110 and a memory 120 operably connected to the processor 110 and including instructions 122.

The apparatus 100 for predicting squeal noise may represent a device that predicts squeal noise and outputs target noise to reduce squeal noise. For example, the apparatus 100 for predicting squeal noise may identify data extracted from a braking device of a vehicle, identify data corresponding to wheels of the vehicle, and identify data measured from an external sensor. The apparatus 100 for predicting squeal noise may apply the identified data to a squeal noise prediction model to obtain an expected probability that squeal noise will be generated in the braking device. The apparatus 100 for predicting squeal noise may be configured to determine whether the braking device generates squeal noise based on a comparison of the obtained probability and a predetermined threshold value. When squeal noise is expected to be generated, the apparatus 100 for predicting squeal noise may output target noise configured for reducing or canceling out the squeal noise to reduce or cancel out the squeal noise. The apparatus 100 for predicting squeal noise may offset the squeal noise by outputting target noise through an output device such as a speaker included in the vehicle.

The apparatus 100 for predicting squeal noise may provide convenience to occupants in the vehicle by outputting target noise. Furthermore, the apparatus 100 for predicting squeal noise may be configured to determine a location where the target noise is to be output by determining whether an occupant is on board and the location of the occupant based on connections with portable terminals of occupants boarding the vehicle. The apparatus 100 for predicting squeal noise may more precisely predict squeal noise which may be perceived by the occupants boarding the vehicle, based on data measured through microphones of the portable terminals of the occupants boarding the vehicle. The apparatus 100 for predicting squeal noise may output target noise that reduces or offset the squeal noise perceivable by a driver by receiving whether squeal noise is generated from the driver among the occupants in the vehicle.

The processor 110 may execute software and control at least another component (e.g., a hardware or software component) connected to the processor 110. The processor 110 may also perform various data processing or operations. For example, the processor 110 may store first input data, second input data, third input data, and the like in the memory 120.

For reference, the processor 110 may perform all operations performed by the apparatus 100 for predicting squeal noise. Therefore, for convenience of explanation, in the present specification, operations performed by the apparatus 100 for predicting squeal noise are mainly described as operations performed by the processor 110. Furthermore, in the present specification, for convenience of explanation, the processor 110 is mainly described as being a single processor, but the exemplary embodiment of the present disclosure is not limited thereto. For example, the apparatus 100 for predicting squeal noise may include at least one processor. Each of the at least one processor is configured to perform all operations related to squeal noise prediction and target noise output.

The memory 120 may temporarily and/or permanently store various data and/or information required to perform all operations related to squeal noise prediction and target noise output. For example, the memory 120 may store first input data, second input data, third input data, and the like.

The apparatus 100 for predicting squeal noise may further include a communication device. For example, the communication device may support communication between the apparatus 100 for predicting squeal noise and an external device (e.g., a server). For example, the communication device may include at least one component that enables communication between the apparatus 100 for predicting squeal noise and an external device. For example, the communication device may include a short range wireless communication unit, a microphone, and the like. In the instant case, short-range communication technologies include wireless LAN (Wi-Fi), Bluetooth, ZigBee, Wi-Fi direct (WFD), ultra-wideband (UWB), infrared data association (IrDA), Bluetooth low energy (BLE), Near Field Communication (NFC), and the like, but the exemplary embodiment of the present disclosure is not limited thereto.

FIG. 2 is a flowchart illustrating a method of predicting squeal noise according to an exemplary embodiment of the present disclosure.

According to an exemplary embodiment of the present disclosure, in operation 210, an apparatus for predicting squeal noise (e.g., the apparatus 100 for predicting squeal noise in FIG. 1) may identify vehicle state data including at least one of first input data extracted from a braking device of a vehicle, second input data corresponding to a wheel of the vehicle, third input data measured from an external sensor of the vehicle, or any combination thereof.

In operation 220, the apparatus for predicting squeal noise may obtain first output data on a probability that the squeal noise is expected to be generated in the braking device, and second output data on a frequency of the squeal noise, and third output data on an amplitude of the squeal noise by applying the vehicle state data to a squeal noise prediction model. For example, the squeal noise prediction model may represent a model trained and/or learning through machine learning, and may be a trained machine learning model that outputs a training output (e.g., the first output data, the second output data and the third output data) from a training input (e.g., vehicle state data).

In detail, the squeal noise prediction model may include a neural network. The neural network may include a plurality of layers, and each layer may include a plurality of nodes. A node may include a node value determined based on an activation function. A node in an arbitrary layer may be connected to a node (e.g., another node) in another layer through a link (e.g., a connection edge) with a connection weight. The node value of a node may be propagated to other nodes through links. In the inference operation of a neural network, node values may be forward propagated from the previous layer to the next layer.

For example, in the squeal noise prediction model, a forward propagation operation may represent an operation of propagating a node value based on input data in a direction from an input layer of the squeal noise prediction model to an output layer. That is, a node value of a corresponding node may be propagated (e.g., forward propagation) to a node (e.g., a next node) of a next layer connected to a node through a connection edge. For example, a node may receive a value weighted by a connection weight from a previous node (e.g., a plurality of nodes) connected through a connection edge.

A node value of a node may be determined based on applying an activation function to a sum (e.g., a weighted sum) of weighted values received from previous nodes. Parameters of the neural network may include the connection weight described above as an example. The parameters of the neural network may be updated so that the value of a loss function changes in a targeted direction (e.g., a direction in which loss is minimized).

A machine learning model (e.g., a trained squeal noise prediction model) may be generated through machine learning. For example, a learning algorithm may include supervised learning, unsupervised learning, semi-supervised learning, or reinforcement learning, but is not limited to the above examples.

A learning algorithm may include a machine learning system that includes an algorithm that performs learning from data. Such an algorithm may include artificial intelligence, operating a computer without an external program, automatic reasoning, automatic adaptation, automatic decision, automatic learning, a function of a computer automatically learning without an external program, artificial intelligence (AI), or any combination thereof. Machine learning may include classification, regression analysis, feature learning, online learning, unsupervised learning, supervised learning, cluster analysis, dimensionality reduction, structure prediction, abnormal behavior detection, neural networks, or any combinations thereof.

The machine learning model may include a plurality of artificial neural network layers. In detail, the trained squeal noise prediction model may include a shared layer including at least one convolution operation and a plurality of classifier layers connected to the shared layer. The artificial neural network may include at least one of a deep neural networks (DNN), a convolutional neural network (CNN), a u-net for image segmentation (U-net) a recurrent neural network (RNN), a restricted boltzmann machine (RBM), a deep belief network (DBN), a bidirectional recurrent deep neural network (BRDNN), a deep Q-network, or a combination thereof, but embodiments are not limited to the above examples.

For example, the trained squeal noise prediction model may be a mixed effect reflection machine learning model. In the instant case, the mixed effect reflection machine learning model may include a regression methodology that outputs squeal noise prediction probability from input data, and may include a methodology that considers distribution-based random effects. As an exemplary embodiment of the present disclosure, the mixed effect reflection machine learning model may include linear regression, logistic regression, classification and regression tree algorithms, a support vector machine (SVM), Naive Bayes, a K-nearest neighbor, a random forest algorithm, XGBoost, LightGBM, and mixed effects random forests (MERF), mixed effect light gradient boosting (MELGB), or the like.

In operation 230, the apparatus for predicting squeal noise may output target noise and, by use of the target noise, cancels out the squeal noise that corresponds to the second output data and the third output data and is generated from the braking device based on the squeal noise expected to be generated from the braking device through the first output data. For example, the apparatus for predicting squeal noise may regard squeal noise as noise, weaken the squeal noise, and output the weakened squeal noise. In detail, the apparatus for predicting squeal noise may attenuate the squeal noise considered as noise in noise canceling schemes, and output target noise which is relatively strengthened audio and voice signals in a specific direction based on the second output data and third output data.

FIG. 3 is a diagram illustrating a method of obtaining data for predicting whether squeal noise occurs by an apparatus for predicting squeal noise according to an exemplary embodiment of the present disclosure.

An apparatus for predicting squeal noise (e.g., the apparatus 100 for predicting squeal noise of FIG. 1) according to various exemplary embodiments of the present disclosure may preprocess a raw data set 330 received from a braking device 310, a wheel 320, and an external sensor of a vehicle 300 to obtain vehicle state data 340 at a target time point when the braking device 310 of the vehicle 300 operates.

The apparatus for predicting squeal noise may be configured to generate first input data that includes at least one of hydraulic data (e.g., denoted as ‘X3 Pressure’ in FIG. 3) related to the oil pressure applied to the braking device 310, disk temperature data (e.g., denoted as ‘X2 Temp’ in FIG. 3), torque data related to the torque applied to the disk (e.g., denoted as ‘X4 Torque’ in FIG. 3), or any combination thereof.

At the target time point, the apparatus for predicting squeal noise may be configured to generate second input data that includes at least one of wheel speed data (e.g., denoted as ‘X1 Speed’ in FIG. 3) related to the speed of the wheel 320, rolling circumference data (e.g., denoted as ‘X6 rolling circumference’ in FIG. 3) of a tire coupled to the wheel 320, or any combination thereof.

At the target time point, the apparatus for predicting squeal noise may be configured to generate third input data that includes at least one of outside air temperature data (e.g., denoted as ‘X5 outside air temperature’ in FIG. 3), humidity data (e.g., denoted as ‘X7 humidity’ in FIG. 3), or any combination thereof.

The apparatus for predicting squeal noise may preprocess the raw data set 330 including the first input data, the second input data, and the third input data to obtain the vehicle state data 340. For example, the apparatus for predicting squeal noise may obtain the vehicle state data 340 by binding a plurality of sub-input data generated by preprocessing the raw data set 330.

The apparatus for predicting squeal noise may be configured to generate first sub-input data including the square of disk temperature data (i.e., the process of preprocessing disk temperature data, the same as below) and the square of wheel speed data.

The apparatus for predicting squeal noise may be configured to generate second sub-input data that includes the wheel speed data and a change in wheel speed data at a subsequent time point following the target time point, the disk temperature data and a change in disk temperature data at the subsequent time point, the hydraulic pressure data and a change in hydraulic pressure data at the subsequent time point, and the torque data and a change in torque data at the subsequent time point.

The apparatus for predicting squeal noise may be configured to generate third sub-input data that includes first torque estimation data generated based on the wheel speed data and a change in wheel speed data at the subsequent time point following the target time point, and second torque estimation data generated based on the first torque estimation data and the disk temperature data. A detailed description of the first sub-input data, second sub-input data, and third sub-input data will be described with reference to FIG. 4 below.

The apparatus for predicting squeal noise may obtain the vehicle state data 340 by binding the first sub-input data, second sub-input data, and third sub-input data. However, the scheme of obtaining the vehicle state data 340 is not limited to the above. For example, the apparatus for predicting squeal noise may obtain the vehicle state data 340 through preprocessing of torque wheel raw data obtained based on at least one of the torque applied to the braking device 310, the torque applied to the wheel 320, the torque applied to a regenerative braking motor 370, or any combination thereof.

The apparatus for predicting squeal noise may apply the results (e.g., first output data, second output data, and third output data) output from the squeal noise prediction model 350 to a control logic 360. By applying the output result to the control logic 360, the apparatus for predicting squeal noise may adjust and/or correct hydraulic braking of the braking device 310, or adjust and/or correct regenerative braking of a regenerative braking motor.

For example, the apparatus for predicting squeal noise may be configured to determine the hydraulic control mode of the vehicle 300 based on the squeal noise generated in the braking device 310. The apparatus for predicting squeal noise may be configured to determine a torque compensating amount corresponding to the determined hydraulic control mode, based on an amount of hydraulic pressure reduction corresponding to the determined hydraulic control mode, the friction coefficient between a disk and a pad included in the braking device 310, and a piston area of the disk included in the braking device 310. The apparatus for predicting squeal noise may apply the torque compensating amount to at least one of a motor for generating braking force through regenerative braking in the vehicle 300, a motor for generating braking force through an electronic parking brake of the vehicle 300, and a transmission for generating braking force through engine braking in the vehicle 300, or any combination thereof, and generate braking force lost by the hydraulic pressure reduction amount to brake the vehicle 300. In particular, by use of regenerative braking, the apparatus for predicting squeal noise may improve fuel efficiency by additionally recovering energy through regenerative braking in an operation of reducing or cancelling out squeal noise.

The apparatus for predicting squeal noise may be configured to determine whether the braking device 310 generates squeal noise based on a comparison of the first output data and a predetermined threshold value. The apparatus for predicting squeal noise may output target noise through a sound actuator 380 included in the vehicle 300, based on the squeal noise expected to be generated in the braking device 310.

FIG. 4 is a diagram illustrating input data in an apparatus for predicting squeal noise according to an exemplary embodiment of the present disclosure.

Referring to FIG. 4, vehicle state data may include data obtained by preprocessing raw data received from a braking device, a wheel and the external sensor of a vehicle.

The vehicle state data may include following variables. For example, the item ‘disc_1c_2d’ may mean the square of disk temperature data. In the instant case, the value determined by squaring the disk temperature data may include the relationship between the range of change in the temperature of the disk and the range of variation in the friction coefficient between the disk and the pad as the temperature increases.

The item ‘deceleration’ may mean the change (e.g., a difference, hereinafter referred to as a change) in wheel speed data at time point ‘t’ and wheel speed data at time point ‘t-n’. For example, changes in wheel speed data may include deceleration that includes a linear relationship with the friction coefficient between the disk and pad, based on the linear relationship between torque and deceleration.

The item ‘temp_rate’ may mean the difference between disk temperature data at time point ‘t’ and disk temperature data at time point ‘t-n’ as a change in disk temperature data. For example, the change in disk temperature data may include a relationship between the range of change in the temperature of the disk and the range of variation in the friction coefficient between the disk and the pad.

The item ‘temp_jerk’ may mean the difference between the change in disk temperature data at time point ‘t’ and the change in disk temperature data at time point ‘t-n’. For example, the change in the change in disk temperature data may include not only the change in disk temperature data, but also the relationship between the changes in the changed object.

The item ‘press_rate’ may mean the difference between hydraulic data at time point ‘t’ and hydraulic data at time point ‘t-n’. For example, the change in hydraulic data may include a physical phenomenon in which the friction coefficient between the disk and pad are affected by pressure.

The item ‘torque_est’ may mean the ratio of the change in wheel speed data and hydraulic pressure data as the first torque estimation data. For example, the first torque estimation data may represent data generated based on characteristics of deceleration that include a linear relationship with torque.

The item ‘torque_est_temp’ may mean the result of multiplying the first torque estimation data by the disk temperature data as the second torque estimation data. For example, the second torque estimation data may represent data generated based on characteristics that reflect the influence of temperature on characteristics of deceleration that include a linear relationship with torque.

The item ‘ke’ may mean the square of wheel speed data as the kinetic energy of the vehicle. The item ‘ke_cumsum’ may mean the sum of the kinetic energy for a specified time period of the vehicle as the accumulated value of the vehicle's kinetic energy.

The item ‘torque_rate’ may mean the difference between torque data at time point ‘t’ and torque data at time point ‘t-n’. In the instant case, the torque data at time point ‘t’ and the torque data at time point ‘t-n’ may represent the first torque estimation data at the time ‘t’ and the first torque estimation data at time point ‘t-n’, or the second torque estimation data at time point ‘t’ and the second torque estimation data at time point at time point ‘t-n’, respectively. For example, changes in torque data may include the characteristic that the greater the change in torque applied to the braking device, the more unstable the friction coefficient between the disk and the pad.

However, the variables included in the vehicle state data are not limited to the above. For example, the apparatus for predicting squeal noise may obtain vehicle state data by preprocessing raw data related to the braking device of the vehicle. Therefore, in the present specification, for convenience of explanation, the variables included in the vehicle state data will be mainly described with the variables shown in FIG. 4.

FIG. 5 is a flowchart illustrating a method of outputting target noise in an apparatus for predicting squeal noise according to an exemplary embodiment of the present disclosure.

In operation 510, an apparatus for predicting squeal noise (e.g., the apparatus 100 for predicting squeal noise in FIG. 1) according to various exemplary embodiments of the present disclosure may output or identify a vehicle driving state, identify data measured by a hands-free microphone, and identify data measured by a microphone interworking with a smartphone. For example, the vehicle driving state output by the apparatus for predicting squeal noise may represent vehicle state data. In detail, the apparatus for predicting squeal noise may identify first noise data measured from a first external device provided in the vehicle and second noise data measured from a second external device of a user operating the vehicle. In the instant case, the first external device may represent a hands-free microphone, and the second external device may represent a microphone interworking with a smartphone. The apparatus for predicting squeal noise may include at least one of the first noise data, the second noise data, or any combination thereof in vehicle state data.

In operation 520, the apparatus for predicting squeal noise may be configured to determine whether squeal noise occurs from a squeal noise prediction model based on the data identified in operation 510. For example, the apparatus for predicting squeal noise may apply vehicle state data to a squeal noise prediction model to obtain first output data, second output data, and third output data. The apparatus for predicting squeal noise may perform the operations described in operations 530 to 560 based on the squeal noise expected to be generated in the braking device through the first output data.

In operation 530, the apparatus for predicting squeal noise may be configured to determine the outside air temperature and soaking time based on the squeal noise expected to be generated in the braking device. In detail, the apparatus for predicting squeal noise may identify second output data and third output data obtained from the squeal noise prediction model based on whether the outside air temperature is low and the vehicle soaking time. The details will be described with reference to FIG. 6 below.

In operation 540, the apparatus for predicting squeal noise may be configured to determine the squeal noise generation location. For example, the apparatus for predicting squeal noise may be configured to determine the position of the squeal noise generating wheel. When the position of the squeal noise generating wheel is determined, the apparatus for predicting squeal noise may obtain output data related to the squeal noise from a squeal noise prediction sub-model corresponding to the determined position. The details will be described with reference to FIG. 7 below.

In operation 550, the apparatus for predicting squeal noise may be configured to determine the location of the occupant inside the vehicle and determine the output priority of the target noise. Thus, the apparatus for predicting squeal noise may output the target noise in operation 560.

FIG. 6 is a flowchart illustrating a method of classifying the characteristics of squeal noise according to outside air temperature and soaking time in an apparatus for predicting squeal noise according to an exemplary embodiment of the present disclosure.

An apparatus for predicting squeal noise (e.g., the apparatus 100 for predicting squeal noise in FIG. 1) according to various exemplary embodiments of the present disclosure may identify at least one of an outside air temperature measured from an external sensor, soaking time of a vehicle, or any combination thereof based on the expectation that squeal noise will be generated in a braking device through the first output data.

In operation 610, when the outside air temperature and the soaking time are identified, the apparatus for predicting squeal noise may compare the outside air temperature with a first threshold value (e.g., 0° C.). In other words, the apparatus for predicting squeal noise may identify a first sub-condition, which is a result of comparing the outside air temperature with the first threshold value. When the first sub-condition is a condition in which the outside air temperature is less than the first threshold value, the apparatus for predicting squeal noise may identify a second sub-condition, which is a result of comparing the soaking time with a second threshold value in operations 620 and 630. In the instant case, the soaking time may represent the driving time of the vehicle.

In operation 640, when the outside air temperature is less than the first threshold value and the soaking time is greater than the second threshold value, the apparatus for predicting squeal noise may obtain the frequency of the characteristic squeal noise and the amplitude of the squeal noise at a temperature lower than a predetermined temperature and soaking. In operation 650, the apparatus for predicting squeal noise may obtain the frequency of the characteristic squeal noise and the amplitude of the squeal noise at a temperature lower than a predetermined temperature or soaking, when the outside air temperature is less than the first threshold value and the soaking time is less than the second threshold value or when the outside air temperature is equal to or greater than the first threshold value and the soaking time is greater than the second threshold value. Finally, in operation 660, when the outside air temperature exceeds the first threshold value and the soaking time is less than the second threshold value, the apparatus for predicting squeal noise may obtain the frequency of the characteristic squeal noise and the amplitude of the squeal noise at a temperature lower than a predetermined temperature and soaking.

FIG. 7 is a flowchart illustrating the operation of a squeal noise prediction sub-model corresponding to a sub-region in an apparatus for predicting squeal noise according to an exemplary embodiment of the present disclosure.

In operation 710, an apparatus for predicting squeal noise (e.g., the apparatus 100 for predicting squeal noise in FIG. 1) according to various exemplary embodiments of the present disclosure may be configured to determine whether squeal noise occurs. For example, the apparatus for predicting squeal noise may apply vehicle state data to a squeal noise prediction model and obtain an expected probability that the squeal noise will be generated in the braking device to determine whether squeal noise occurs.

In operation 720, the apparatus for predicting squeal noise may be configured to determine the squeal noise prediction sub-model corresponding to each of at least one sub-region determined by dividing the region of the vehicle by a predetermined number based on the center portion of the vehicle, based on the squeal noise expected to be generated. For example, the apparatus for predicting squeal noise may divide the region of the vehicle by a number corresponding to the number of wheels of the vehicle. In detail, when the vehicle includes four wheels, the apparatus for predicting squeal noise may divide the vehicle region into four sub-regions (e.g., FL region, FR region, RL region, and RR region).

In operation 730, the apparatus for predicting squeal noise may apply the vehicle state data to each of the squeal noise prediction sub-models to obtain the first output data, second output data, and third output data corresponding to each of the sub-regions. For example, the squeal noise prediction model may include as many squeal noise prediction sub-models as the number of sub-regions. The squeal noise prediction sub-model may represent a model that predicts squeal noise occurring in a specified region.

In detail, when a vehicle includes four wheels, the apparatus for predicting squeal noise may divide the region of the vehicle into four sub-regions: a first sub-region (e.g., FL region), and a second sub-region (e.g., FR region), a third sub-region (e.g., RL region), and a fourth sub-area (e.g., RR region). In the instant case, the apparatus for predicting squeal noise may be configured to determine squeal noise prediction sub-models corresponding to each of the sub-areas. For example, the squeal noise prediction sub-models may include a first squeal noise prediction sub-model (e.g., FL region), a second squeal noise prediction sub-model (e.g., FR region), and a third squeal noise prediction sub-model (e.g., RL region), and a fourth squeal noise prediction sub-model (e.g., RR region). The apparatus for predicting squeal noise may apply the vehicle state data to the squeal noise prediction sub-models corresponding to each sub-region. The apparatus for predicting squeal noise may obtain first output data, second output data, and third output data from the squeal noise prediction sub-models corresponding to each sub-region. The apparatus for predicting squeal noise may combine outputs obtained from squeal noise prediction sub-models corresponding to each sub-region to determine whether squeal noise occurs in the vehicle.

FIG. 8 is a flowchart illustrating a method of outputting target noise according to the location of an occupant and target noise output priority in an apparatus for predicting squeal noise according to an exemplary embodiment of the present disclosure.

An apparatus for predicting squeal noise (e.g., the apparatus 100 for predicting squeal noise in FIG. 1) according to various exemplary embodiments of the present disclosure may be configured to determine whether occupants sit in each seat in operation 810. For example, the apparatus for predicting squeal noise may identify the locations of occupants in a vehicle based on squeal noise expected to be generated in a braking device. based on identifying the locations of the occupants, the apparatus for predicting squeal noise may be configured to determine the identified location as the location for outputting the target noise.

The apparatus for predicting squeal noise may identify the locations of occupants based on operations described below. For example, the apparatus for predicting squeal noise may be configured to determine first location data for identifying the locations of the occupants boarding the vehicle, based on a weight detection sensor included in the vehicle. The apparatus for predicting squeal noise may be configured to determine second location data for identifying the locations of the occupants boarding the vehicle, based on at least one of an ultrasonic sensor, a radar sensor, or any combination thereof included in the vehicle. The apparatus for predicting squeal noise may be configured to determine third location data for identifying the locations of the occupants boarding the vehicle, based on the connections between the vehicle and portable terminals of the occupants boarding the vehicle. The apparatus for predicting squeal noise may identify the locations of the occupants boarding the vehicle based on at least one of first location data, second location data, third location data, or any combination thereof.

In operation 820, the apparatus for predicting squeal noise may be configured to predict audible noise (i.e., squeal noise which may be heard by an occupant) around the seat in which the occupant sits. As an exemplary embodiment of the present disclosure, the apparatus for predicting squeal noise may obtain noise information from a smartphone microphone of the occupant connected to a hands-free microphone of the vehicle. The apparatus for predicting squeal noise may be configured to determine the priority for outputting the target noise based on the obtained noise information.

In operation 830, the apparatus for predicting squeal noise may receive the priority regarding the output of the target noise from the driver. For example, based on the fact that the number of identified locations is at least one, the apparatus for predicting squeal noise may provide a notification to the driver of the vehicle to input the priority of the location at which the target noise is output.

In operation 840, the apparatus for predicting squeal noise may output the target noise for each location corresponding to the order of priority, based on the priority input. For example, the priority may include the order of target noise output at the driver's seat location, target noise output at the occupant seat location, and target noise output at the rear seat location. Furthermore, the apparatus for predicting squeal noise may provide the driver with a priority selection function in an order of rear right seat, rear left seat, occupant seat, and driver's seat.

FIG. 9 is a diagram illustrating a computing system related to an apparatus for predicting squeal noise or a method of controlling squeal noise according to various exemplary embodiments of the present disclosure.

Referring to FIG. 9, a computing system 1000 related to an apparatus for predicting squeal noise or a method of controlling squeal noise may include at least one processor 1100 connected through a system bus 1200, a memory 1300, a user interface input device 1400, a user interface output device 1500, a storage 1600, and a network interface 1700.

The processor 1100 may be a central processing unit (CPU) or a semiconductor device that processes instructions stored in the memory 1300 and/or the storage 1600. The memory 1300 and the storage 1600 may include various volatile or nonvolatile storage media. For example, the memory 1300 may include a read only memory (ROM) and a random access memory (RAM).

Accordingly, the processes of the method or algorithm described in relation to the exemplary embodiments of the present disclosure may be implemented directly by hardware executed by the processor 1100, a software module, or a combination thereof. The software module may reside in a storage medium (that is, the memory 1300 and/or the storage 1600), such as a RAM memory, a flash memory, a ROM memory, an EPROM memory, an EEPROM memory, a register, a hard disk, a detachable disk, or a CD-ROM.

The exemplary storage medium is coupled to the processor 1100, and the processor 1100 may read information from the storage medium and may write information in the storage medium. In another method, the storage medium may be integrated with the processor 1100. The processor and the storage medium may reside in an application specific integrated circuit (ASIC). The ASIC may reside in a user terminal. In another method, the processor and the storage medium may reside in the user terminal as an individual component.

The above description is a simple exemplification of the technical spirit of the present disclosure, and the present disclosure may be variously corrected and modified by those skilled in the art to which the present disclosure pertains without departing from the essential features of the present disclosure.

The exemplary embodiments described above may be realized by hardware elements, software elements and/or combinations thereof. For example, the devices and components illustrated in the exemplary embodiments of the present disclosure may be implemented in one or more general-use computers or special-purpose computers, such as a processor, a controller, an arithmetic logic unit (ALU), a digital signal processor, a microcomputer, a field programmable gate array (FPGA), a programmable logic unit (PLU), a microprocessor or any device which may execute instructions and respond. A processing unit may implement an operating system (OS) or one or software applications running on the OS. Furthermore, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Also, the processing unit may include a different processing configuration, such as a parallel processor.

Software may include computer programs, codes, instructions or one or more combinations thereof and may configure a processing unit to operate in a target manner or may independently or collectively control the processing unit. Software and/or data may be permanently or temporarily embodied in any type of machine, components, physical equipment, virtual equipment, computer storage media or units or transmitted signal waves to be interpreted by the processing unit or to provide instructions or data to the processing unit. Software may be dispersed throughout computer systems connected via networks and may be stored or executed in a dispersion manner. Software and data may be recorded in one or more computer-readable storage media.

The methods according to the above-described exemplary embodiments of the inventive concept may be implemented with program instructions which may be executed through various computer means and may be recorded in computer-readable media. The media may also include, alone or in combination with the program instructions, data files, data structures, and the like. The program instructions recorded in the media may be designed and configured specially for the exemplary embodiments of the inventive concept or be known and available to those skilled in computer software. Computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher level codes which may be executed by the computer using an interpreter.

The described hardware devices may be configured to act as one or more software modules to perform the operations of the above-described exemplary embodiments of the inventive concept, or vice versa.

The effects of the apparatus for predicting squeal noise and the method of controlling the same according to an exemplary embodiment of the present disclosure will be described as follows.

According to at least one of the exemplary embodiments of the present disclosure, it is possible to reflect the relationship between rapid changes in the friction coefficient between the disk and the pad and torque estimates to predict the squeal noise by identifying the vehicle state data including the first input data extracted from the braking device of a vehicle, the second input data corresponding to the wheels of the vehicle, and the third input data measured from external sensors of the vehicle, and obtaining the probability that the squeal noise is expected to be generated.

Furthermore, according to at least one of the exemplary embodiments of the present disclosure, it is possible to provide users with the expected squeal noise characteristics and the squeal noise generation conditions by applying the vehicle state data to a squeal noise prediction model, and obtaining the first output data on the probability that squeal noise is expected to be generated in a braking device, the second output data on the frequency of the squeal noise, and the third output data on the amplitude of the squeal noise.

Furthermore, according to at least one of the exemplary embodiments of the present disclosure, it is possible to reflect the level of squeal noise perception from the user's perspective and provide a squeal noise reduction function differentiated depending on the user to maximize driving satisfaction by identifying the locations of the occupants boarding the vehicle and outputting target noise for reducing the squeal noise to the identified locations.

Furthermore, various effects that are directly or indirectly understood through the present disclosure may be provided.

While a few exemplary embodiments have been shown and described with reference to the accompanying drawings, it will be apparent to those skilled in the art that various modifications and variations may be made from the foregoing descriptions. For example, adequate effects may be achieved even if the foregoing processes and methods are conducted in different order than described above, and/or the aforementioned elements, such as systems, structures, devices, or circuits, are combined or coupled in different forms and modes than as described above or be substituted or switched with other components or equivalents.

Thus, it is intended that the present disclosure covers other realizations and other embodiments of the present disclosure provided they come within the scope of the appended claims and their equivalents.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, multiple operations may be merged, or any operation may be divided, and a specific operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operably may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An apparatus for predicting squeal noise, the apparatus comprising:
a memory configured to store computer-executable instructions; and
at least one processor operably connected to the memory and configured to access the memory and execute the instructions,
wherein the at least one processor is configured to:
identify vehicle state data including at least one of first input data extracted from a braking device of a vehicle, second input data corresponding to a wheel of the vehicle, third input data measured from an external sensor of the vehicle, or a combination thereof;
obtain first output data on a probability that the squeal noise is expected to be generated in the braking device, second output data on a frequency of the squeal noise, and third output data on an amplitude of the squeal noise by applying the vehicle state data to a squeal noise prediction model; and
output target noise and, by use of the target noise, cancel out the squeal noise that corresponds to the second output data and the third output data and is generated from the braking device based on the squeal noise expected to be generated from the braking device through the first output data.

2. The apparatus of claim 1, wherein the at least one processor is further configured to:
identify first noise data measured from a first external device provided in the vehicle and second noise data measured from a second external device of a user operating the vehicle; and
include at least one of the first noise data, the second noise data, or a combination thereof in the vehicle state data.

3. The apparatus of claim 1, wherein the at least one processor is further configured to:
identify at least one of outside air temperature measured from the external sensor, soaking time of the vehicle, or a combination thereof based on the squeal noise expected to be generated in the braking device through the first output data;
identify a first sub-condition comparing the outside air temperature with a first threshold value, and a second sub-condition comparing the soaking time with a second threshold value; and
output the target noise based on the first sub-condition and the second sub-condition.

4. The apparatus of claim 1, wherein the at least one processor is further configured to:
obtain the frequency of the squeal noise and the amplitude of the squeal noise at a temperature lower than a predetermined temperature and soaking, in response that an outside air temperature is less than a first threshold value and a soaking time is greater than a second threshold value; or
obtain the frequency of the squeal noise and the amplitude of the squeal noise at the temperature lower than the predetermined temperature or the soaking, in response that the outside air temperature is less than the first threshold value and the soaking time is less than the second threshold value or in response that the outside air temperature is equal to or greater than the first threshold value and the soaking time is greater than the second threshold value; or
obtain the frequency of the characteristic squeal noise and the amplitude of the squeal noise at the temperature lower than the predetermined temperature and the soaking, in response that the outside air temperature exceeds the first threshold value and the soaking time is less than the second threshold value.

5. The apparatus of claim 1, wherein the at least one processor is further configured to:
determine a plurality of sub-areas by dividing an area of the vehicle by a predetermined number based on a center portion of the vehicle;
determine squeal noise prediction sub-models corresponding to each of the sub-areas; and
obtain the first output data, the second output data, and the third output data corresponding to each of the sub-areas to apply the vehicle state data to each of the squeal noise prediction sub-models.

6. The apparatus of claim 1, wherein the at least one processor is further configured to:
identify locations of occupants boarding the vehicle based on the squeal noise expected to be generated in the braking device; and
determine the identified location as a location to which the target noise outputs.

7. The apparatus of claim 6, wherein the at least one processor is further configured to:
determine first location data for identifying the locations of the occupants boarding the vehicle based on a weight sensor included in the vehicle;
determine second location data for identifying the locations of the occupants boarding the vehicle based on at least one of an ultrasonic sensor, a radio detection and ranging (RADAR) sensor, or a combination thereof included in the vehicle;
determine third location data for identifying the locations of the occupants boarding the vehicle based on a connection between the vehicle and portable terminals of the occupants boarding the vehicle; and
identify the locations of the occupants boarding the vehicle based on at least one of the first location data, the second location data, the third location data, or a combination thereof.

8. The apparatus of claim 6, wherein the at least one processor is further configured to:
provide a notification to a driver of the vehicle to input a priority of a location to which the target noise outputs, based on a number of the identified locations being at least one; and
output the target noise for each location corresponding to the priority based on inputting of the priority.

9. The apparatus of claim 1, wherein the at least one processor is further configured to:
determine whether the squeal noise of the braking device occurs based on a comparison of the first output data and a predetermined threshold value; and
output the target noise through a sound actuator included in the vehicle based on the squeal noise expected to be generated in the braking device.

10. The apparatus of claim 1, wherein the at least one processor is further configured to apply the first output data, the second output data and the third output data to the braking device or a regenerative braking motor to adjust hydraulic braking of the braking device, or regenerative braking of the regenerative braking motor.

11. A method of predicting squeal noise, the method comprising:
identifying, by a processor, vehicle state data including at least one of first input data extracted from a braking device of a vehicle, second input data corresponding to a wheel of the vehicle, third input data measured from an external sensor of the vehicle, or a combination thereof;
obtaining, by the processor, first output data on a probability that the squeal noise is expected to be generated in the braking device, second output data on a frequency of the squeal noise, and third output data on an amplitude of the squeal noise by applying the vehicle state data to a squeal noise prediction model; and
outputting, by the processor, target noise and, by use of the target noise canceling out the squeal noise that corresponds to the second output data and the third output data and is generated from the braking device based on the squeal noise expected to be generated from the braking device through the first output data.

12. The method of claim 11, wherein the identifying of the vehicle state data includes:
identifying first noise data measured from a first external device provided in the vehicle and second noise data measured from a second external device of a user operating the vehicle; and
including at least one of the first noise data, the second noise data, or a combination thereof in the vehicle state data.

13. The method of claim 11, wherein the outputting of the target noise includes:
identifying at least one of outside air temperature measured from the external sensor, soaking time of the vehicle, or a combination thereof based on the squeal noise expected to be generated in the braking device through the first output data;
identifying a first sub-condition comparing the outside air temperature with a first threshold value, and a second sub-condition comparing the soaking time with a second threshold value; and
outputting the target noise based on the first sub-condition and the second sub-condition.

14. The method of claim 11, wherein the processor is further configured to:
obtain the frequency of the squeal noise and the amplitude of the squeal noise at a temperature lower than a predetermined temperature and soaking, in response that an outside air temperature is less than a first threshold value and a soaking time is greater than a second threshold value; or
obtain the frequency of the squeal noise and the amplitude of the squeal noise at the temperature lower than the predetermined temperature or the soaking, in response that the outside air temperature is less than the first threshold value and the soaking time is less than the second threshold value or in response that the outside air temperature is equal to or greater than the first threshold value and the soaking time is greater than the second threshold value; or
obtain the frequency of the characteristic squeal noise and the amplitude of the squeal noise at the temperature lower than the predetermined temperature and the soaking, in response that the outside air temperature exceeds the first threshold value and the soaking time is less than the second threshold value.

15. The method of claim 11, further including:
determining, by the processor, a plurality of sub-areas by dividing an area of the vehicle by a predetermined number based on a center portion of the vehicle;
determining, by the processor, squeal noise prediction sub-models corresponding to each of the sub-areas; and
obtaining, by the processor, the first output data, the second output data, and the third output data corresponding to each of the sub-areas to apply the vehicle state data to each of the squeal noise prediction sub-models.

16. The method of claim 11, wherein the outputting of the target noise includes:
identifying locations of occupants boarding the vehicle based on the squeal noise expected to be generated in the braking device; and
determining the identified location as a location to which the target noise outputs.

17. The method of claim 16, wherein the identifying of the locations of the occupants includes:
determining first location data for identifying the locations of the occupants boarding the vehicle based on a weight sensor included in the vehicle;
determining second location data for identifying the locations of the occupants boarding the vehicle based on at least one of an ultrasonic sensor, a radio detection and ranging (RADAR) sensor, or a combination thereof included in the vehicle;
determining third location data for identifying the locations of the occupants boarding the vehicle based on a connection between the vehicle and portable terminals of the occupants boarding the vehicle; and
identifying the locations of the occupants boarding the vehicle based on at least one of the first location data, the second location data, the third location data, or a combination thereof.

18. The method of claim 16, wherein the outputting of the target noise includes:
providing a notification to a driver of the vehicle to input a priority of a location to which the target noise outputs, based on a number of the identified locations being at least one; and
outputting the target noise for each location corresponding to the priority based on inputting of the priority.

19. The method of claim 11, wherein the outputting of the target noise includes:
determining whether the squeal noise of the braking device occurs based on a comparison of the first output data and a predetermined threshold value; and
outputting the target noise through a sound actuator included in the vehicle based on the squeal noise expected to be generated in the braking device.

20. The method of claim 11. further including:
applying, by the processor, the first output data, the second output data and the third output data to the braking device and a regenerative braking motor to adjust hydraulic braking of the braking device, or regenerative braking of the regenerative braking motor.
